(19) United States
(12) Patent Application Publication
(10) Pub. No.: US 2010/0110723 A1
(43) Pub. Date: May 6, 2010

(54) BILLBOARD UTILIZING BACKLIGHT ILLUMINATION

(75) Inventors: CHUN-WEI WANG, Chu-Nan (TW); CHIH-MING LAI, Chu-Nan (TW); HUNG-KUANG HSU, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/493,138

(22) Filed: Jun. 26, 2009

(30) Foreign Application Priority Data
Nov. 5, 2008 (CN) 200810305392.7

(51) Int. Cl. F21V 7/04

(52) U.S. Cl. 362/602; 362/633; 362/609

(57) ABSTRACT

An exemplary billboard includes a frame, a light emitting diode (LED) light source, a display board and a reflect board. The LED light source is fixed on the frame and for emitting lights. The display board is fixed on the frame. The display board includes a light incident surface, a light emitting surface opposite to light incident surface, and at least one through hole extending through the light incident surface and the light emitting surface, the at least one through hole forms a predetermined logo. The reflect board is fixed on the frame and includes a light reflecting surface facing towards the light incident surface of the display board.

### BACKGROUND

1. Technical Field

The present invention generally relates to billboards and, particularly, to a billboard utilizing backlight illumination, and a fabrication method thereof.

2. Discussion of Related Art

Conventional billboards generally include a light transmissive canvas on which patterns are printed and a backlight module for illuminating the light transmissive canvas. Light from the backlight module, however, is partly absorbed when passing through the light transmissive canvas. As such, light utilization efficiency of the billboards is low.

Therefore, what is needed is a billboard capable of overcoming the described shortcomings.

### BRIEF DESCRIPTION OF THE DRAWINGS

Many aspects of the present billboard can be better understood with reference to the following drawings. The components in the drawings are not necessarily drawn to scale, the emphasis instead being placed upon clearly illustrating the principles of the present billboard. Moreover, in the drawings, like reference numerals designate corresponding parts throughout the several views, wherein:

FIG. 1 is a schematic side view of a billboard, according to a first exemplary embodiment.

FIG. 2 is a schematic view of a display board of the billboard illustrated in FIG. 1.

FIG. 3 is a schematic view of a reflect board of the billboard illustrated in FIG. 1.

FIG. 4 is a schematic view of a reflect board according to a variation of the first embodiment.

FIG. 5 is a schematic view of a reflect board according to another variation of the first embodiment.

### DETAILED DESCRIPTION OF THE PREFERRED EMBODIMENTS

Reference will now be made to the drawing to describe the embodiments of the present billboard, in detail.

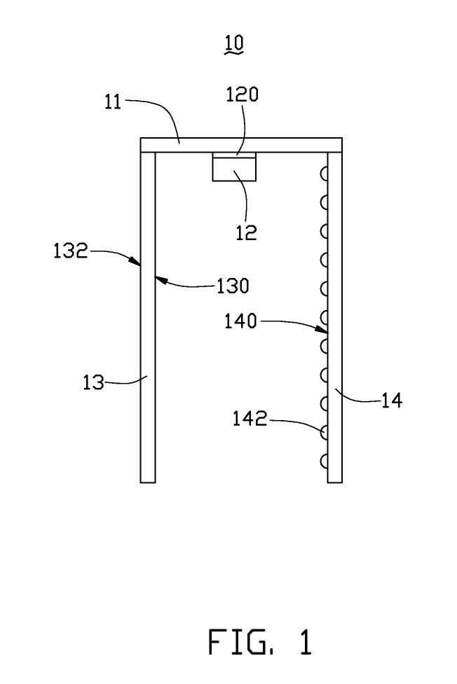

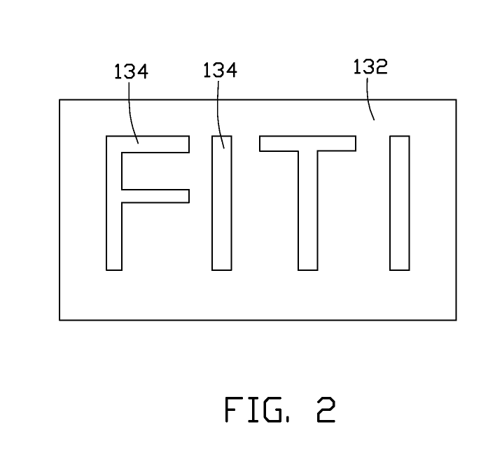

Referring to FIG. 1 and FIG. 2, a billboard 10, according to a first exemplary embodiment, is provided. The billboard 10 includes a frame 11, a light emitting diode (LED) light source 12, a display board 13 and a reflect board 14.

The frame 11 is configured for supporting and fixing the LED light source 12, the display board 13 and the reflect board 14. The frame can be made of metal or plastic. In an exemplary embodiment, the frame 11 is made of metal.

The LED light source 12 is fixed on the frame 11 and configured for emitting lights. In an exemplary embodiment, a thermal interface material 120 is sandwiched between the LED light source 12 and the frame 11. The thermal interface material 120 is configured for transferring heat from the LED light source 12 to the frame 11, thereby assisting heat dissipation of the LED light source 12. The thermal interface material 120 can be thermal grease, thermal paste or a thermal tape.

The display board 13 is fixed on the frame 11 and at one side of the LED light source 12. The display board 13 includes a light incident surface 130, a light emitting surface 132 and at least one through hole 134. The light emitting surface 132 is opposite to the light incident surface 130. The at least one through hole 134 extends through the display board 13 and communicates to the light incident surface 130 and the light emitting surface 132. The at least one through hole 134 forms a predetermined logo, for example “FITI” as illustrated in FIG. 2.

The reflect board 14 is fixed on the frame 11 and at a side of the LED light source 12 opposite to the display board 13. The reflect board 14 includes a light reflecting surface 140 facing towards the light incident surface 130 of the display board 13. The reflect board 14 can be made of metal or plastic. The light reflecting surface 140 has metallic colors or white color. On the condition that part of the lights emitted from the LED source 12 incidents onto the light reflecting surface 140, the light reflecting surface 140 reflects part of lights towards the light incident surface 130 of the display board 13. Thereby, the light use efficiency is improved.

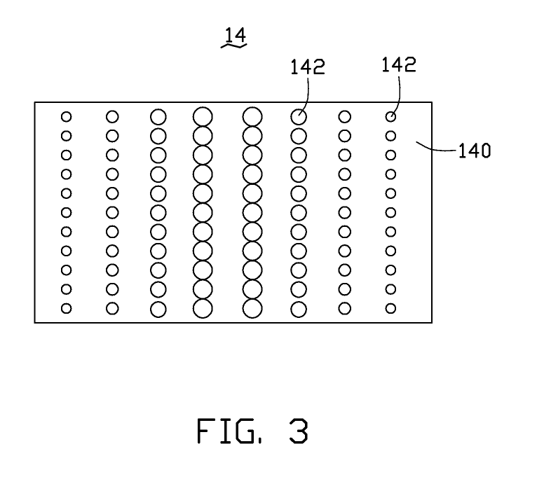

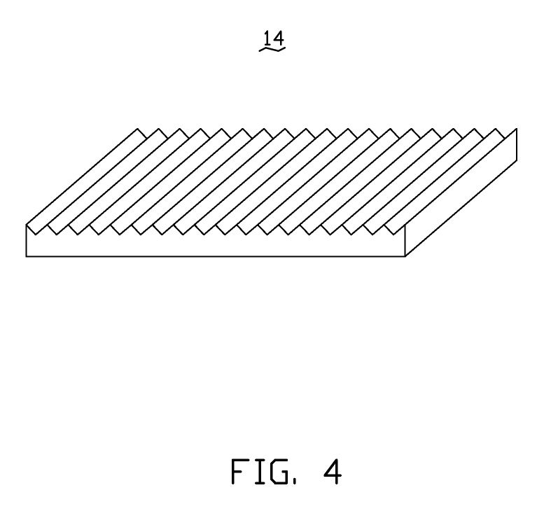

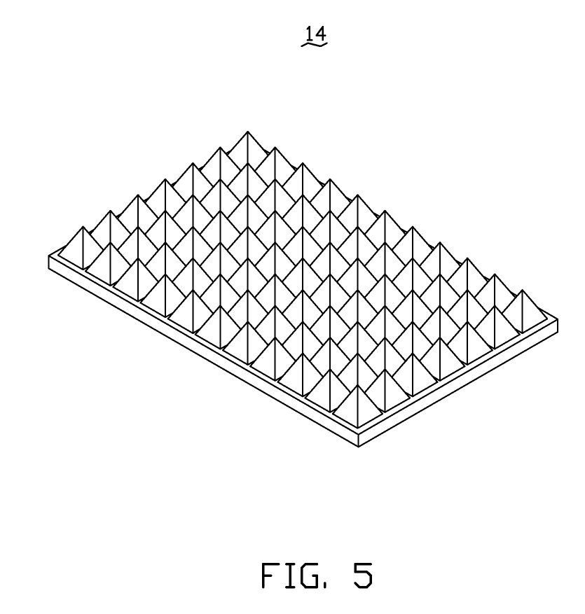

The light reflecting surface 140 can also have micro structure formed thereon, thereby randomly changing directions of the lights reflected by the light reflecting surface 140 and improving light uniformity thereof. In an exemplary embodiment, referring to FIG. 3, the light reflecting surface 140 has a plurality of round dots 142 formed thereon. The sizes of the dots 142 decrease in directions from a middle to opposite sides of the light reflecting surface 140. Alternatively, the dots 142 can also be quadrate. It is to be said that, the light reflecting surface 140 can also have V-shaped grooves (as illustrated in FIG. 4), pyramidal protrusions (as illustrated in FIG. 5) or conical protrusions formed thereon instead.

In summary, the reflect board 14 and the LED source 12 cooperatively act as a backlight module for illuminating the display board 13. With the display board 13 having at least one through hole 134 formed there through, lights passing through the through hole 134 is not absorbed by the display board 13. As such, light utilization efficiency of the billboard 10 is improved.

Finally, it is to be understood that the above-described embodiments are intended to illustrate rather than limit the invention. Variations may be made to the embodiments without departing from the spirit of the invention as claimed. The above-described embodiment illustrates the scope of the invention but do not restrict the scope of the invention.

What is claimed is:

1. A billboard, comprising:
a frame;
an LED light source fixed on the frame and configured for emitting light;
a display board fixed on the frame and at one side of the LED light source, the display board comprising a light incident surface, a light emitting surface opposite to light incident surface, and at least one through hole extending through the light incident surface and the light emitting surface, the at least one through hole configured for forming a predetermined logo; and
a reflect board fixed on the frame and at an side of the LED light source opposite to the display board, the reflect board comprising a light reflecting surface facing towards the light incident surface of the display board.

2. The billboard according to claim 1, wherein the frame is made of metal or plastic.

3. The billboard according to claim 1, further comprising a thermal interface material is sandwiched between the LED light source and the frame.

4. The billboard according to claim 1, wherein the thermal interface material is thermal grease, thermal paste or a thermal tape.

5. The billboard according to claim 1, wherein the reflect board is made of metal or plastic.

6. The billboard according to claim 1, wherein the light reflecting surface has a plurality of V-shaped grooves thereon.

7. The billboard according to claim 1, wherein the light reflecting surface has a plurality of elongated parallel protrusions.

8. The billboard according to claim 1, wherein the light reflecting surface has a plurality of conical or pyramidal dots.

9. The billboard according to claim 8, wherein the sizes of the dots gradually decrease in directions from a middle to opposite sides of the light reflecting surface.
